(19) United States
(12) Patent Application Publication
(10) Pub. No.: US 2010/0060883 A1
(43) Pub. Date: Mar. 11, 2010

(54) Apparatus and method for determining the focus position

(75) Inventor: Michael Heiden, Woelfersheim (DE)

Correspondence Address: Davidson, Davidson & Kappel, LLC, 485 7th Avenue, 14th Floor, New York, NY, 10018, US

(73) Assignee: VISTEC Semiconductor Systems GmbH, Weilburg (DE)

(21) Appl. No.: 12/584,542

(22) Filed: Sep. 8, 2009

(30) Foreign Application Priority Data
Sep. 9, 2008 (DE) 10 2008 044 509.6

(51) Int. Cl. G01M 11/02

(52) U.S. Cl. 356/126

(57) ABSTRACT

An apparatus and a method for determining the focus of an optical system on a substrate are disclosed. A light source emits an auxiliary light beam into an auxiliary beam path, wherein the auxiliary light beam, after splitting, is offset in relation to an optical axis of a measuring objective. At least one optical switch is provided in the auxiliary beam path for switching the path of the auxiliary beam path from one side offset from the optical axis to the other side offset from the optical axis of the measuring objective.

This claims the benefits of German Patent Application No. 10 2008 044 509.6, filed on Sep. 9, 2008, and hereby incorporated by reference herein.

The present invention relates to an apparatus for determining the focus of an optical system. In particular, the invention relates to the determination of a focus of an optical system in relation to a substrate placed on a measuring stage. For this purpose, a light source is provided, which emits an auxiliary light beam into an auxiliary beam path. With respect to an optical axis of a measuring objective, the auxiliary light beam is offset from this optical axis.

The present invention also relates to a method of determining the focus position. The focus of an optical system is determined in relation to a substrate.

### BACKGROUND

German patent specification DE 102 04 367 B4 discloses an auto-focus module for microscope-based systems, and also an auto-focusing method for microscope-based systems. A first auxiliary illumination and a second auxiliary illumination are used to determine the focus on the surface of a substrate. The optical arrangement is configured in such a way that each light beam emitted by both the first auxiliary illumination and the second illumination is offset from the optical axis of a measuring objective. Also, a detector is associated with each auxiliary beam path of the first auxiliary illumination and the second auxiliary illumination. By alternately switching on the first auxiliary illumination and the second illumination it is possible to determine the precise focus position on the surface of the substrate with the aid of the two detectors. A focus has been achieved if the intensity measured by the two detectors assumes the same value.

### SUMMARY OF THE INVENTION

It is an object of the present invention to provide an apparatus for determining the focus position, which is reliably suitable for determining the position of the focus on the surface of a substrate and at the same time reduces the number of necessary optical elements to a minimum.

The present invention provides an apparatus comprising:

a measuring objective defining an optical axis;

a light source which emits an auxiliary light beam in an auxiliary beam path, wherein each auxiliary light beam, after splitting, is offset in relation to the optical axis of the measuring objective; and

at least one optical switch provided in the auxiliary beam path for switching the path of the auxiliary light beam from one side offset from the optical axis to the other side offset from the optical axis of the measuring objective.

Another object of the present invention is to provide a method for determining the focus of an optical system on a substrate wherein the optical elements needed to carry out the method have been reduced to a minimum.

The present invention also provides a method for determining the focus of an optical system on a substrate, comprising the following steps:
mapping at least one auxiliary light beam emitted by a light source with the aid of at least one lens onto an optical switch, which is provided in an optical axes of the apparatus;
operating the optical switch in such a way that a path of the auxiliary light beam is switched from one side offset from the optical axis to the other side offset from the optical axis of the measuring objective; and
directing the auxiliary light beam returning from the substrate onto a position-sensitive detector by means of a beam splitter.

The apparatus for determining the focus of an optical system on a substrate may comprise a light source which emits an auxiliary beam in an auxiliary beam path. The auxiliary beam is arranged in relation to an optical axis of a measuring objective in such a way that it is offset from the optical axis of the measuring objective. An optical switch is provided in the auxiliary beam path for switching the path of the auxiliary beam from one side offset from the optical axis to the other side offset from the optical axis.

Upstream of the optical switch, at least one lens may be arranged which maps the auxiliary light beam emitted by the light source onto the optical switch. Downstream of the optical switch, at least one further optical element can be provided. The optical element upstream of the optical switch may be a lens. The optical element downstream of the optical switch can be at least one diffractive optical element or at least one lens for shaping the auxiliary light beam.

A transportation optics may be arranged upstream of the measuring objective for mapping the offset of the auxiliary light beam in relation to the optical axis of the pupil of the apparatus into the pupil of the measuring objective.

A beam splitter, which transmits the auxiliary beam, may be arranged between the optical switch and the measuring objective. This beam splitter directs a light beam returning from the substrate on the other side of the optical axis onto a position-sensitive detector. The position-sensitive detector can be formed as a two-quadrant diode, as a four-quadrant diode, as a line sensor or as a surface sensor.

In one embodiment, the optical switch is formed as an acousto-optic modulator (AOM). Another possibility is for the optical switch to be an optical mechanical switch, such as a piezo mirror or a DMD. Furthermore, the optical switch can also be formed as an electro-optical switch. A magneto-optical switch is also conceivable as an optical switch. The light source is a laser which emits the auxiliary light beam used for determining the focus position. The at least one lens arranged upstream of the optical switch maps the auxiliary light beam into the optical switch. Possible wavelengths of interest are 193 nm, 248 nm, 266 nm, 375 nm, 405 nm or 903 nm.

The light source can also have a mirror system arranged immediately downstream of it, which splits the auxiliary light beam into two respective partial light beams extending on either side of the optical axis. Each of the two partial auxiliary light beams is directed via a respective acousto-optic modulator (AOM), which, depending on the switching state, transmits the partial auxiliary light beam into the one or the other half of the pupil of the measuring objective. A beam trap is downstream of each acousto-optical modulator for trapping the partial auxiliary light beam which is currently not supposed to pass into the half of the pupil of the measuring objective. This is to ensure that no scattered light from the unwanted partial auxiliary light beam passes onto the position-sensitive detector used for determining the focus position.

The method of determining the focus of an optical system at first comprises the step of mapping at least one auxiliary light beam emitted by a light source with the aid of at least one lens onto an optical switch provided in an auxiliary light beam. The optical switch is operated or switched in such a way that a path of the auxiliary light beam on one side offset from the optical axis can be switched to another side offset from the optical axis of the measuring objective. The auxiliary light beam returned from the substrate is directed onto a position-sensitive detector with the aid of a beam splitter.

Since only one light source is provided which emits an auxiliary light beam, this auxiliary light beam is cyclically switched by the optical switch. By these means the auxiliary light beam passes first on one side offset from the optical axis of the measuring objective, and after switching the auxiliary light beam extends on the other side offset from the optical axis of the measuring objective. In each case the auxiliary light beam returning from the substrate is directed onto a different place of the position-sensitive detector as a function of its path as set by the optical switch. The optimum focus position has been achieved once the two signals of the auxiliary light beams impinging on the position-sensitive detector have the same value. More detail on this can be derived from the above-mentioned patent specification DE 102 04 367.

Even though the use of the apparatus for adjusting the optimum focus position is described in the following description as used in a coordinate measuring machine, it goes without saying for a person skilled in the art that the application of this inventive system for adjusting the focus position can be used in a great variety of optical systems.

### BRIEF DESCRIPTION OF THE DRAWINGS

Exemplary embodiments, the invention and its advantages will be described in the following in more detail with reference to the accompanying drawings, in which:

FIG. 1 diagrammatically shows a coordinate-measuring machine in which the apparatus for determining the focus position is used;

FIG. 2 is a diagrammatic view of the apparatus for determining the focus position in combination with a measuring objective whose focus position is to be determined in relation to a surface of a substrate;

FIG. 3 is a diagrammatic view of the apparatus for determining the focus position;

FIG. 4 shows the position of the auxiliary light beam within the entry pupil of the measuring objective;

FIG. 5 is a diagrammatic view of the apparatus for determining the focus position, wherein the optical switch has assumed another switching state than the one of FIG. 3;

FIG. 6 shows the position of the auxiliary light beam within the entry pupil of the measuring objective according to the switching state shown in FIG. 5, of the optical switch.

FIG. 7 shows another embodiment of the apparatus for determining the focus position, wherein an optical component for beam shaping is associated with the apparatus;

FIG. 8 shows an auxiliary light beam formed by the element shown in FIG. 7 filling one half of the entry pupil of the measuring objective;

FIG. 9 shows the other switching state of the apparatus for determining the focus position shown in FIG. 7;

FIG. 10 shows the filling state of the entry pupil of the measuring objective according to the switching state shown in FIG. 9 of the apparatus for adjusting the focus position;

FIG. 11 shows another embodiment of the apparatus for determining the focus position, wherein two separately switchable optical switches are provided in the auxiliary beam path;

FIG. 12 is a diagrammatic view of the path of the partial auxiliary light beam within the entry pupil of the measuring objective, wherein the switching state of FIG. 11 has been set;

FIG. 13 shows the other switching state of the optical switch in comparison to FIG. 13; and

FIG. 14 is a diagrammatic view of the path of the partial auxiliary light beam within the entry pupil of the measuring objective.

### DETAILED DESCRIPTION

The following description refers to an apparatus for adjusting the focus position of an optical system. The optical system discussed in the description is a coordinate measuring machine. It goes without saying for a person skilled in the art that the apparatus for adjusting the focus position can also be applied to other optical systems and the description referring to a coordinate measuring machine should not be construed as a limitation of the invention. Furthermore, it should be noted that in the various figures the same reference numerals will be used to indicate the same or equivalent elements.

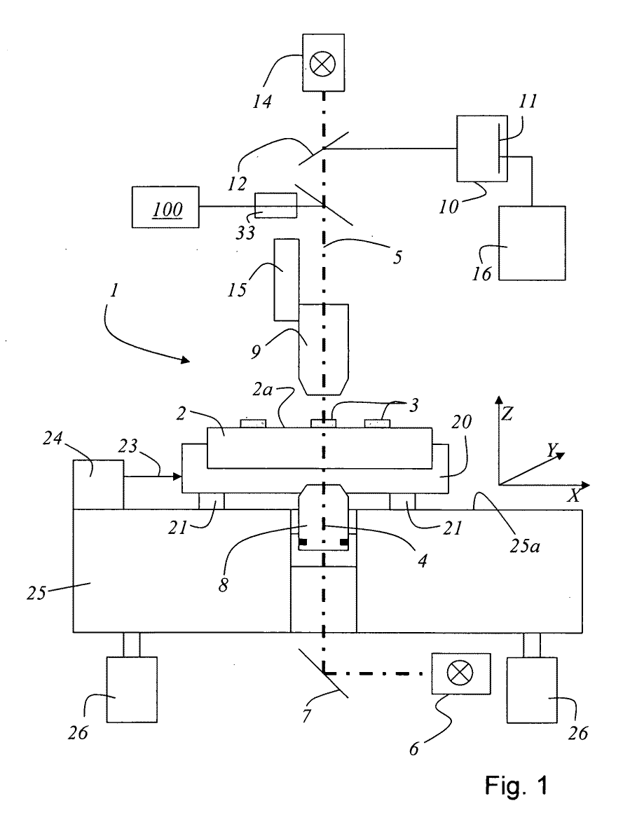

FIG. 1 is a diagrammatic view of a coordinate measuring machine 1, in which the apparatus according to the present invention and the method according to the present invention are applied. A mask 2 carrying structures 3 to be measured on its surface 2a is inserted in a measuring stage 20 arranged moveably in a plane 25a in the X coordinate direction and the Y coordinate direction. Plane 25a is formed by a block. Block 25 is of granite in a preferred embodiment. It should not be construed as limiting the invention, however, that block 25 is of granite. It goes without saying for a person skilled in the art that plane 25a, within which the measuring stage is moved, can be made of any suitable material. The movability of measuring stage 20 is achieved by means of suitable bearings 21. In a preferred embodiment, bearings 21 are formed as air bearings. The position of measuring stage 20 within plane 25a is measured by means of at least one laser interferometer 24. To measure the position of measuring stage 20, laser interferometer 24 directs a laser beam 23 onto measuring stage 20. Even if only one interferometer 24 is shown, this should not be construed as limiting the invention. It goes without saying for a person skilled in the art that each moveable element of a coordinate measuring machine 1 can be monitored by means of a laser interferometer with respect to its position in space.

To illuminate mask 2, a transmitted-light illuminating means 6 and an incident-light illuminating means 14 are provided in the coordinate measuring machine. From transmitted-light illuminating means 6, the illuminating light is directed onto mask 2 via a redirecting mirror and a condenser 8. Starting from the incident-light illuminating means 14, the light of the incident-light illuminating means 14 is directed along an incident-light illuminating beam path 5 via measuring objective 9 onto mask 2. Measuring objective 9 can be adjusted in the Z coordinate direction by means of an adjusting means 15. This is used to adjust the focus position of the measuring objective 9. Measuring objective 9 collects the light coming from mask 2 and directs it via a splitting mirror onto a detector 10 provided with a detector chip 11. The output of the detector chip is coupled to a computer 16 comprising a memory 18. Computer 16 digitizes the image signals recorded by the detector and feeds them to the computer and/or a control unit for further processing. In memory 18 of computer 16, corresponding correction data can be stored. The correction data are usually organized in the computer in the form of a database structure. The entire coordinate measuring machine 1 rests on vibration dampers 26 to isolate against building vibrations or vibrations of the ambience so that measuring values are not falsified by these vibrations.

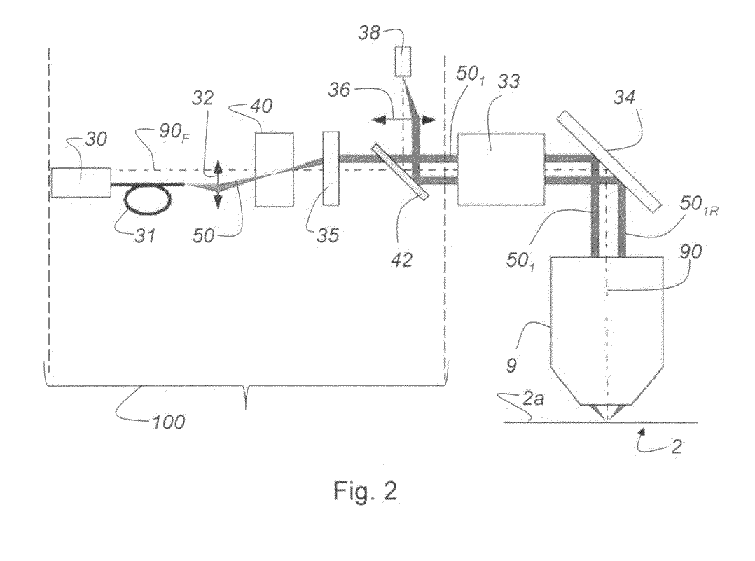

FIG. 2 is a diagrammatic view of apparatus 100 for adjusting the focus position in combination with a measuring objective 9 whose focus is to be determined, and also adjusted, in relation to the surface 2a of a substrate 2. Apparatus 100 comprises a light source 30, which is a laser in the embodiment shown. The light of the laser is transported in an optical fiber 31. In a preferred form, optical fiber 31 is a monomode fiber. The light of auxiliary light beam 50 exiting from the optical fiber 31 is mapped onto an optical switch 40 by means of a lens 32. The optical switch 40 is capable of switching the light of light source 30 in such a way that on the one hand it extends on one side of the optical axis 90_{F} of apparatus 100, and on the other hand it extends on the other side of the optical axis 90_{F} of apparatus 100. In the embodiment shown here, downstream of optical switch 40, a diffractive optical element 35 is arranged, which serves for beam shaping. In addition, a lens function can also be integrated in this element. First auxiliary light beam 50₁ extends on one side of the optical axis 90_{F} of apparatus 100. Auxiliary light beam 50₁ impinges on a transportation optics 33, which directs auxiliary light beam 50₁ onto measuring objective 9 via a beam splitter 34. Herein, in a preferred variant, the pupil of apparatus 100 is mapped onto the pupil of objective 9 by means of transportation optics 33. Beam splitter 34 can be configured as a dichroic beam splitter which completely reflects the light from light source 30 and completely transmits the light of the incident-light illumination and/or the transmitted-light illumination. Auxiliary light beam 50_{1R} returning from substrate 2 passes via beam splitter 34 and transportation optics 33 to a further beam splitter 42, which directs auxiliary light beam 50_{1R} returning from substrate 2 onto a detector 38. The detector 38 also has a lens 36 upstream of it for mapping the light of auxiliary light beam 50_{1R} returning from substrate 2 on the detector. Optical switch 40 can assume two switching states. Only one switching state is shown in FIG. 2. In the switching state shown here, auxiliary light beam 50₁ extends in such a way that it enters into the entry pupil of measuring objective 9 offset from optical axis 90.

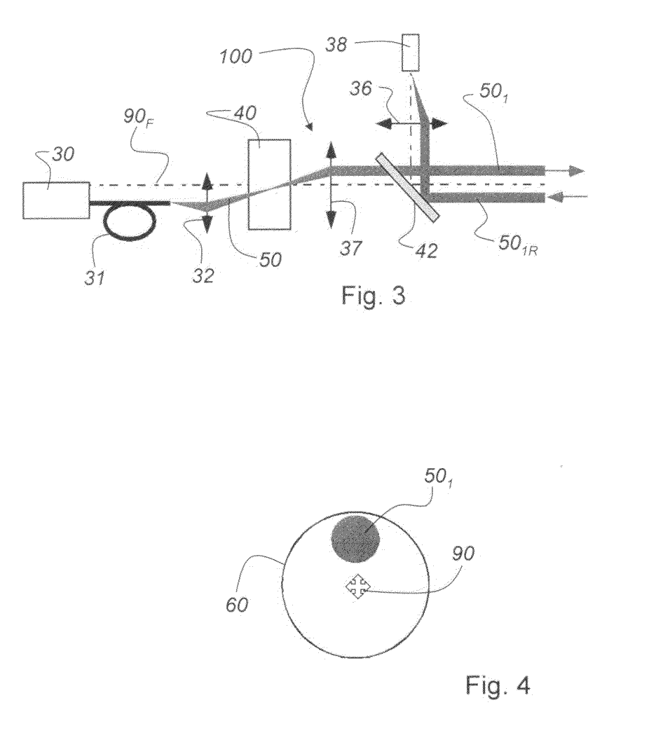

FIG. 3 is a diagrammatic view of apparatus 100 according to an embodiment of the present invention. The light emitted by light source 30 is transported by means of an optical fiber 31. The light is mapped onto the optical switch 40 by means of a lens 32. In the view shown in FIG. 3, the first switching state of optical switch 40 is shown. Auxiliary light beam 50₁ thus extends on one side of optical axis 90_{F} of apparatus 100. The light coming out of optical switch 40 is correspondingly shaped by means of a lens 37. Light 50_{1R} returning from the surface of the substrate extends on the other side of optical axis 90_{F} of apparatus 100. Light beam 50_{1R} returning from substrate 2 is directed onto detector 38 by means of redirecting mirror 42. Lens 36 maps the light onto detector 38 in a corresponding fashion. FIG. 4 shows the path of auxiliary light beam 50₁ within entry pupil 60 of the measuring objective. Due to the switching state of optical switch 40 shown in FIG. 3, auxiliary light beam 50₁ extends on one side of optical axis 90 of measuring objective 9.

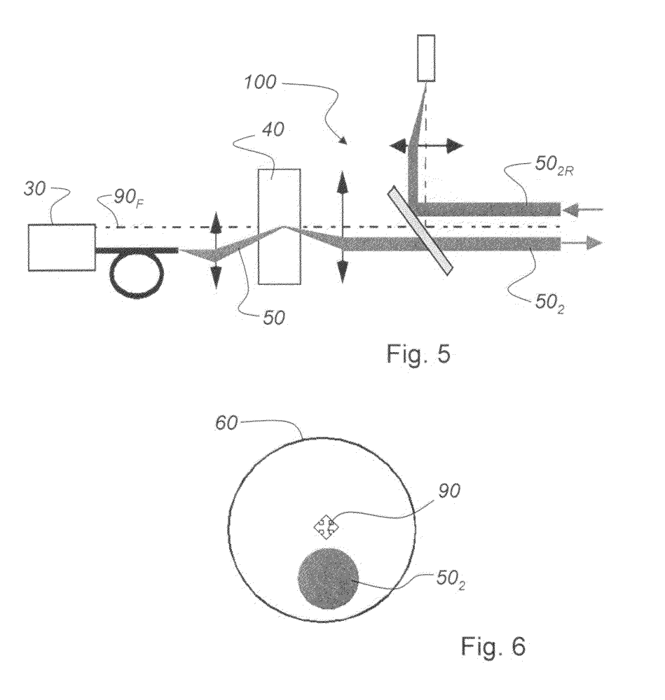

FIG. 5 is a diagrammatic view of the embodiment shown in FIG. 3 of apparatus 100, wherein optical switch 40 has been switched into the other switching state. As can be seen from the view of FIG. 5, auxiliary light beam 50₂ now extends on the other side of optical axis 90_{F} of apparatus 100, than that shown in FIG. 3. Also, auxiliary light beam 50_{2R} returns from substrate 2 on the corresponding opposite side of optical axis 90_{F} of apparatus 100. FIG. 6 shows the path of auxiliary light beam 50₂ within entry pupil 60 of objective 9. Auxiliary light beam 50₂ correspondingly extends on the other side of optical axis 90 of measuring objective 9 in contrast to the path of the auxiliary light beam 50₁ shown in FIG. 4.

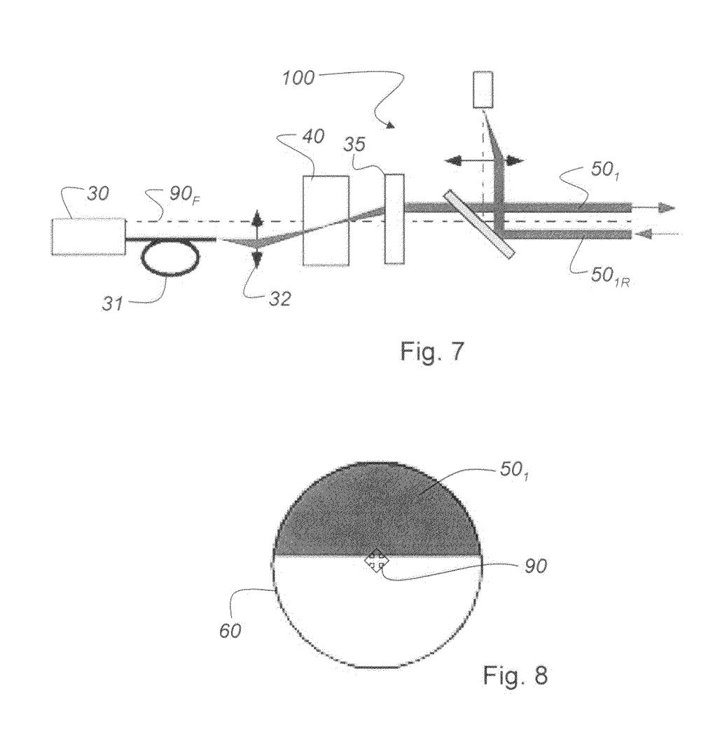

FIG. 7 shows the embodiment of apparatus 100 in detail, which has been described with reference to FIG. 2. Instead of lens 37 downstream of optical switch 40, a diffractive optical element 35 is inserted in optical axis 90_{F} of apparatus 100. It goes without saying that lenses for focusing or shaping auxiliary light beam 50₁ can be used in addition to diffractive optical element 35. Diffractive optical element 35 is configured in such a way that it shapes auxiliary light beam 50₁ so that it essentially fills the entire half of entry pupil 60 of measuring objective 9 in the view shown in FIG. 8. Depending on the application of the auto-focus, other distributions of the light in the entry pupil of the objective are also conceivable and advantageous. In the figures described so far, the light from light source 30 passes to the first lens 32 upstream of the optical switch 40 via an optical fiber 31. It goes without saying for a person skilled in the art that the light of light source 30, which is a laser, can also pass to the corresponding optical switch 40 as an open beam.

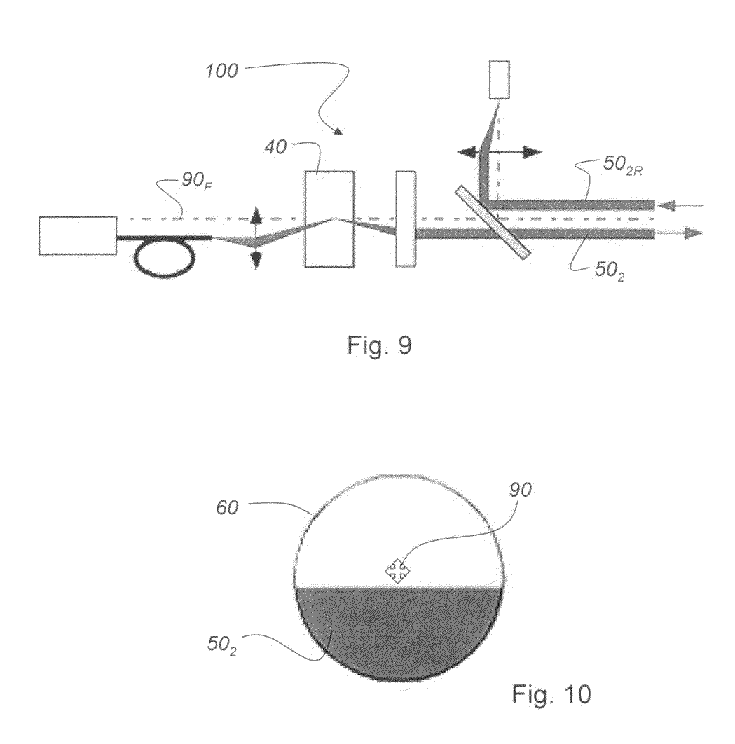

FIG. 9 shows the situation in which optical switch 40 is in the second switching position. Here, auxiliary light beam 50₂ extends on the other side of optical axis 90_{F} of apparatus 100 as shown by the switching state of optical switch 40 in FIG. 7. Auxiliary light beam 50₂ is shaped by diffractive optical element 35 in the same way as shown in FIG. 8. Due to the different switching state of optical switch 40, as shown in FIG. 10, auxiliary light beam 50₂ is now on the other side of optical axis 90 within entry pupil 60 of measuring objective 9. Auxiliary light beam 50₂ is shaped in such a way that it fills about half the entry pupil 60 of measuring objective 9.

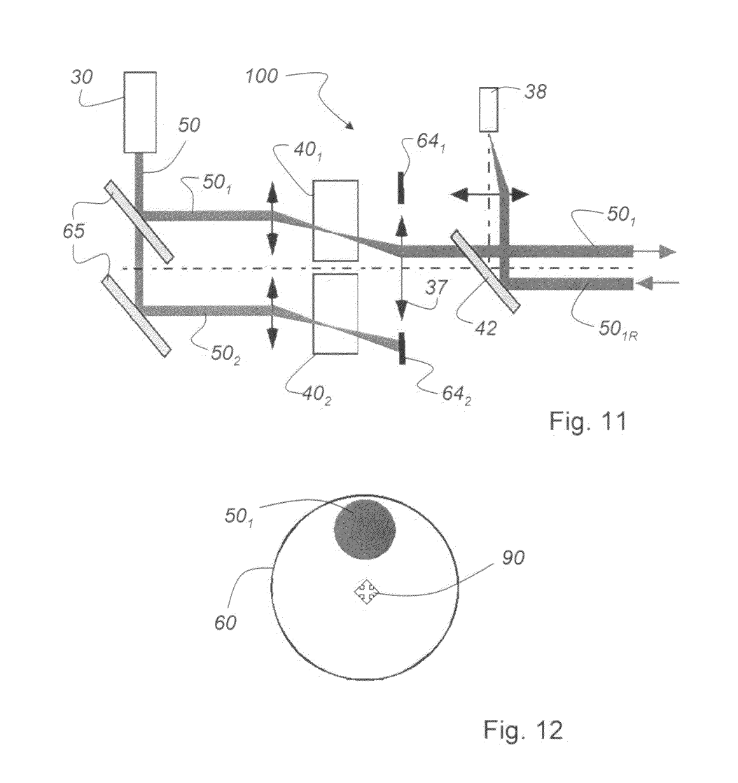

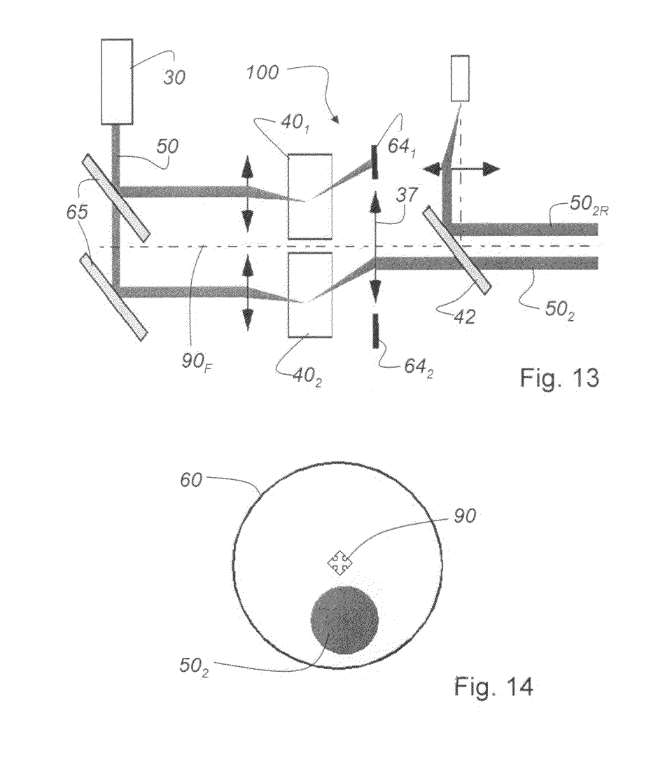

In FIGS. 11 and 13, another embodiment of apparatus 100 is shown. The difference with respect to the embodiments of apparatus 100 described so far lies in that the light coming from light source 30 is already split into a first auxiliary light beam 50₁ and a second auxiliary light beam 50₂ by a mirror system 65 prior to the light impinging on optical switch 40. In the embodiment shown in FIGS. 11 and 13, optical switch 40 comprises a first independent optical switch 40₁ and a second independent optical switch 40₂. In the embodiment shown in FIG. 11, first optical switch 40₁ is in the switching state in which first auxiliary light beam 50₁ is transmitted by beam splitter 42 and can pass to measuring objective 9. Second optical switch 40₂ is switched in a state in which second auxiliary light beam 50₂ impinges on a second beam trap 64₂. The optical switches are thus operated purely as shutters. It goes without saying that any other type of shutters can be used which allow the light to be alternately switched. Beam trap 64₂ is arranged in such a way that it is suitable for trapping any scattered light of second auxiliary light beam 50₂, so that the measurement by detector 38 of the light 50_{1R} returning from substrate 2 is not disturbed. FIG. 12 shows the result of the switching state shown in FIG. 11 of first optical switch 40₁ and second optical switch 40₂. Here, first auxiliary light beam 50₁ extends within entry pupil 60 of measuring objective 9 in such a way that it is on one side of optical axis 90 of measuring objective 9.

FIG. 13 shows the switching situation of first optical switch 40₁ and second optical switch 40₂ of apparatus 100 shown FIG. 11. Second optical switch 40₂ is switched in such a way that second auxiliary light beam 50₂ no longer impinges on beam trap 64₂. Second auxiliary light beam 50₂ thus passes to redirecting mirror 42, which ultimately redirects the auxiliary light beam to measuring objective 9, offset from optical axis 90_{F}. FIG. 14 shows the path of second auxiliary light beam 50₂ within entry pupil 60 of the measuring objective. Second auxiliary light beam 50₂ extends on the other side of optical axis 90 of the measuring objective than that shown in FIG. 12. In the views of the embodiments in FIG. 11 and FIG. 13, a lens 37 is arranged downstream of optical switch 40₁ and of optical switch 40₂. It goes without saying for a person skilled in the art that in the embodiments shown in FIGS. 11 and 13 a diffractive element can also be used, as already shown in the view of FIG. 2. The diffractive element 35 makes it thus possible that an entire segment of entry pupil 60 of measuring objective 9 is filled.

The invention has been described with reference to preferred embodiments. It is also conceivable, however, to make changes and modifications without leaving the scope of protection of the appended claims.

What is claimed is:

1. An apparatus for determining the focus of an optical system on a substrate, comprising:
a measuring objective defining an optical axis;
a light source emitting an auxiliary light beam in an auxiliary beam path, wherein each auxiliary light beam, after splitting, is offset in relation to the optical axis of the measuring objective; and
at least one optical switch in the auxiliary beam path for switching the path of the auxiliary light beam from one side offset from the optical axis to the other side offset from the optical axis of the measuring objective.

2. The apparatus according to claim 1, wherein at least one lens is arranged upstream of the optical switch, the least one lens for mapping the auxiliary light beam coming from the light source onto the optical switch, or for focusing a laser beam into the optical switch.

3. The apparatus according to claim 1, wherein at least one further optical element is provided downstream of the optical switch.

4. The apparatus according to claim 3, characterized in that the at least one further optical element is at least one lens.

5. The apparatus according to claim 3, characterized in that the at least one further optical element is at least one diffractive optical element shaping the auxiliary light beam.

6. The apparatus according to claim 5, wherein a lens function is integrated in the beam-shaping diffractive element.

7. The apparatus according to claim 1, wherein a transporting optics is arranged between the apparatus and the measuring objective of the optical system for mapping the pupil of the apparatus into the pupil of the measuring objective.

8. The apparatus according to claim 1, wherein, between the optical switch and the measuring objective, a beam splitter is arranged, the beam splitter transmitting each auxiliary light beam and directing a light beam returning from the substrate on the other side of the optical axis onto a position-sensitive detector.

9. The apparatus according to claim 8, wherein the position-sensitive detector is configured as a two-quadrant diode or as a four-quadrant diode or as a line sensor or as a surface sensor.

10. The apparatus according to claim 1, wherein the optical switch is an optical mechanical switch or an electro-optical switch or an acousto-optical switch or a magneto-optical switch.

11. The apparatus according to claim 1, wherein the light source is a laser, which emits the auxiliary light beam, wherein the at least one lens arranged upstream of the optical switch maps or focuses the auxiliary light beam into the optical switch.

12. The apparatus according to claim 11, wherein the laser emits light in a wavelength of 193 nm, 248 nm, 266 nm, 375 nm, 405 nm or 903 nm.

13. The apparatus according to claim 1, wherein the light source has a mirror system arranged downstream of it for splitting the auxiliary light beam into two auxiliary light beams each extending on either side of the optical axis, wherein, depending on the switching state, each passes into the one or the other half pupil of the measuring objective via a respective acousto-optic modulator and a beam trap is arranged downstream of each of the acousto-optic modulators.

14. The apparatus according to claims 1, further comprising an optical fiber transporting the light of the light source.

15. A method for determining the focus of an optical system on a substrate, comprising the following steps:
mapping at least one auxiliary light beam emitted by a light source with the aid of at least one lens onto an optical switch, which is provided in an optical axes of the apparatus;
operating the optical switch in such a way that a path of the auxiliary light beam is switched from one side offset from the optical axis to the other side offset from the optical axis of the measuring objective; and
directing the auxiliary light beam returning from the substrate onto a position-sensitive detector by means of a beam splitter.

16. The method according to claim 15, wherein, downstream of the optical switch, at least one further optical element directs the auxiliary light beam exiting from the optical switch parallel to the optical axis of the apparatus.

17. The method according to claim 16, wherein the at least one further optical element is at least one diffractive optical element with the aid of which the auxiliary beam is shaped.

18. The method according to claim 15, wherein by cyclically switching the optical switch the auxiliary light beam is guided on the one side offset from the optical axis or on the other side offset from the optical axis of the measuring objective, in that the auxiliary light beam returning from the substrate impinges on a different place on the position-sensitive detector depending on its path and is evaluated by an electronics unit.

19. The method according to claim 15, wherein an electronics unit evaluates a center of gravity of the signal on the detector for the two positions of the optical switch and in that an optimum focus position is achieved once the two centers of gravity of the auxiliary light beams impinging on the position-sensitive detector have the same value.
